(19) United States
(12) Patent Application Publication
(10) Pub. No.: US 2011/0264565 A1
(43) Pub. Date: Oct. 27, 2011

(54) FINANCIAL COMPUTER SYSTEM THAT DETERMINES AND REPORTS TRANSACTIONS IMPACTED BY ORGANIZATIONAL CHANGES

(75) Inventors: Kristen DOHERTY, Menlo Park, CA (US); Nigel KING, San Mateo, CA (US); Daniela KANTOROVA, Belmont, CA (US)

(73) Assignee: ORACLE INTERNATIONAL CORPORATION, Redwood Shores, CA (US)

(21) Appl. No.: 12/764,559

(22) Filed: Apr. 21, 2010

(51) Int. Cl. G06Q 10/00

(52) U.S. Cl. 705/30

(57) ABSTRACT

A financial computer system in response to receiving a business object to be changed, a change type, and a effective date of the change, identifies all first transactions directly associated with the business object and identifies all second transactions not directly associated with the business object but that may be posted to the business object in the future. The system then displays the first transactions and the second transactions in a user interface.

### FIELD

One embodiment is directed generally to a computer system, and in particular to a financial computer system that records business transactions.

### BACKGROUND INFORMATION

Many business organizations use integrated financial computer systems to track and calculate all kinds of transactions. These computer systems typically include a general ledger, and may include business objects such as cost centers that track costs that accumulate in the general ledger, and profit centers that track profits for the organization or a portion of the organization. One example of an integrated financial computer system is the “Oracle E-Business Suite Financials” from Oracle Corp.

Business organizations frequently reorganize. A reorganization generally is a management initiated realignment of enterprise or division resources to better address operational objectives. Since cost centers are typically the most detailed level at which the consumption of resources is measured and tracked, it is an obvious focus of reorganizations. A reorganization frequently results in the restructuring of reporting relationships within an enterprise without changes to the legal structure of the enterprise. Such restructuring may cause people, quota, budgets and organization hierarchy nodes to be reassigned to different cost centers or departments. Reorganizations vary in size and scope from reorganizations of teams within a single department to changes that impact many aspects of the organization, including operational and financial reporting hierarchies, accounting rules, payroll assignments, security rules, budgets, etc.

### SUMMARY

One embodiment is a financial computer system that, in response to receiving a business object to be changed, a change type, and a effective date of the change, identifies all first transactions directly associated with the business object and identifies all second transactions not directly associated with the business object but that may be posted to the business object in the future. The system then displays the first transactions and the second transactions in a user interface.

### BRIEF DESCRIPTION OF THE DRAWINGS

FIG. 1 is a block diagram of a computer system that can implement an embodiment of the present invention.

FIG. 2 illustrates a user interface of an impacted transaction report summary in accordance with one embodiment of the invention.

FIG. 3 illustrates a user interface when a specific transaction category from the user interface of FIG. 2 is selected for review in accordance with one embodiment of the invention.

FIG. 4 is a flow diagram of the functionality of the impacted transactions module when determining and displaying transactions affected by an organizational change in accordance with one embodiment.

### DETAILED DESCRIPTION

One embodiment is a financial computer system that determines which transactions are affected or will be affected in the event of a reorganization or other type of change to a cost center or department. Such transactions include those that are directly assigned to the changed cost center, as well as transactions that may potentially be assigned to the cost center in the future. A report is then generated listing all of the affected transactions.

During a typical business reorganization, many cost centers may need to be reassigned, or their meaning changed or end-dated (i.e., closed) so that general ledger transactions can no longer be posted to them. This can cause problems because there may be many different types of transactions that will be posting to this cost center in the future but are not currently associated with the cost center. In prior art financial systems, the person that is maintaining the cost center definitions in the chart of accounts typically does not have easily obtainable visibility to these transactions. Instead, finding all of the impacts of a reorganization in prior known systems is typically a tedious and manual process where information must be queried from many different places and consolidated manually in order to have visibility to all impacted transactions across the business. Feedback is typically not given from systems on the administrative costs of trapping and redirecting transactions, nor are options available to delay implementation of changes until the queue of transactions that would be impacted has been bled dry.

These “indirectly affected” transactions can include items such as expense reports, project cross charges, purchase orders, or sales expenses. The person that is making the changes to the chart of accounts needs to at least be made aware that there are transactions which upon further processing may impact this cost center in order to assess the correct course of action. They may choose to delay the chart of accounts maintenance activities. They may choose to reassign the transaction to a new cost center. They may choose to send the transaction back to the originator and ask them to resubmit. However, because prior art financial accounting systems generally do not check for the indirectly related transactions, future transactions may be either posted to an incorrect cost center or will not able to be posted and will be stuck in a queue awaiting investigation. This can lead to underreporting of expenses and potentially misstatements in accounts.

In contrast, embodiments of the invention are a cost center change validator that generates a listing of all the types of transactions that may post to or influence posting to cost centers and provide a report to the person that determines the accounting for that type of transaction. For example, a purchase requisition may derive the charge to a cost center from the work assignment of the employee. Embodiments of the invention also store the way to identify if the transaction is already processed. For example, a requisition may have been considered in a requisition pool from which a purchase order has been created. The person in charge of chart of accounts or cost center maintenance can implement embodiments of the invention for validation of a given proposed cost center change and see the number of transactions for each transaction type. They can drill into the transaction detail and decide on the disposition on an individual transaction.

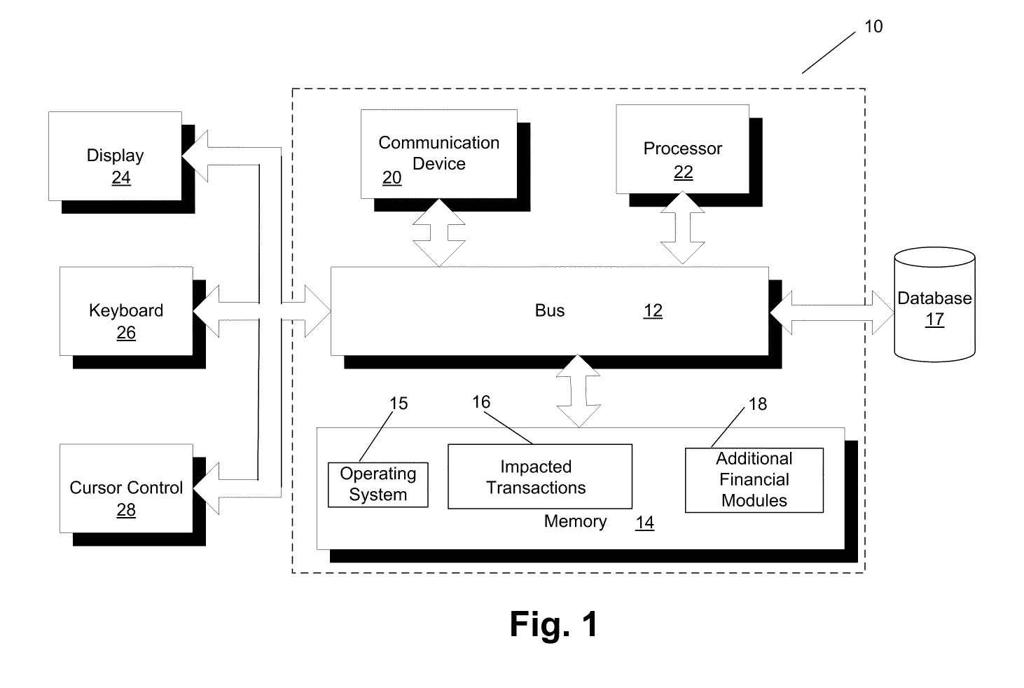

FIG. 1 is a block diagram of a computer system 10 that can implement an embodiment of the present invention. Although shown as a single system, the functionality of system 10 can be implemented as a distributed system. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A keyboard 26 and a cursor control device 28, such as a computer mouse, is further coupled to bus 12 to enable a user to interface with system 10.

In one embodiment, memory 14 stores software modules that provide functionality when executed by processor 22. The modules include an operating system 15 that provides operating system functionality for system 10. The modules further include an impacted transactions module 16 that determines and reports transactions impacted by cost center and other business object changes, as disclosed in more detail below. System 10 can be part of a larger system, such as an Integrated Financial system or Enterprise Resource Planning (“ERP”) system that generates the financial and organization data used by module 16. Therefore, system 10 will typically include one or more additional functional modules 18 to include the additional functionality. For example, module 18 may include “Oracle E-Business Suite Financials” from Oracle Corp. A database 17 may be coupled to bus 12 to provide centralized storage for modules 16 and 18.

In one embodiment, an impacted transaction may be one of two types. One type is already directly associated with a cost center using a business object attribute. Therefore, this transaction can easily be identified as being impacted or affected when its associated cost center is changed. The other type of transaction is not yet directly associated with a cost center, but will potentially impact the cost center in the future. For example, a “sales lead” does not impact a cost center until the lead results in a sale, at which point a sales representative may be awarded a credit. This credit ultimately will impact a specific cost center. In this case, the sub-ledger accounting setup data (i.e., the configuration rules which tell the system how to determine to which account any particular transaction should be posted) must be evaluated to determine which transactions will be associated with the cost center at some point in the future. When users are given visibility to these future transactions, they then have a choice about how to handle them including an option to change the processing setup rules such that a different cost center will be used in the future. This type of visibility is not generally available in prior systems. Known systems also have various places where default cost centers are entered that can be used to populate transactions during accounting and reporting. For instance, worker assignments may have a default cost center. Embodiments of the invention can identify areas of setup where the cost center is entered for defaulting purposes.

Embodiments of the invention facilitate steps to ensure that the change or end-dating of an organization is implemented correctly across all areas of the business. For example, when a cost center is end-dated, there may be expense reports charged to this cost center which are going through the approval process which need to be looked at to determine which should post to the old cost center and which should be redirected to the new cost center. There will be subledger accounting setups which need to change so that future transactions which would have been assigned to this cost center are now assigned to the new cost center or appropriately divided between the new cost centers. For human resource (“HR”) departments, all people assigned to this cost center must be reassigned, and if the department is also a project expenditure organization as well as a department, then those transactions must be closed out and possibly a new project organization implemented to match the new department.

Some of these changes are recommended by the system, and others depend on human analysis and judgment in order to determine which way they should be handled to best reflect the intent of the reorganization being performed. Functionality of embodiments gives users visibility into all potential transactions and setup information which may be affected by the change/end-dating of a cost center or department.

One embodiment allows users to run a report by selecting the cost center (or department) which is to be changed, the type of change to the cost center (e.g., end-dating, change of parent within the primary organization chart, or change of reporting attributes such as a change of manager or management segment assigned to the cost center, etc.), and the date on which the change is to take effect. A result summary screen shows how many transactions have been found in each transaction category and how much of the review process has been completed for each category. A user may also manually mark a category as complete if they know that they do not need to take any action on any of the transactions in this category.

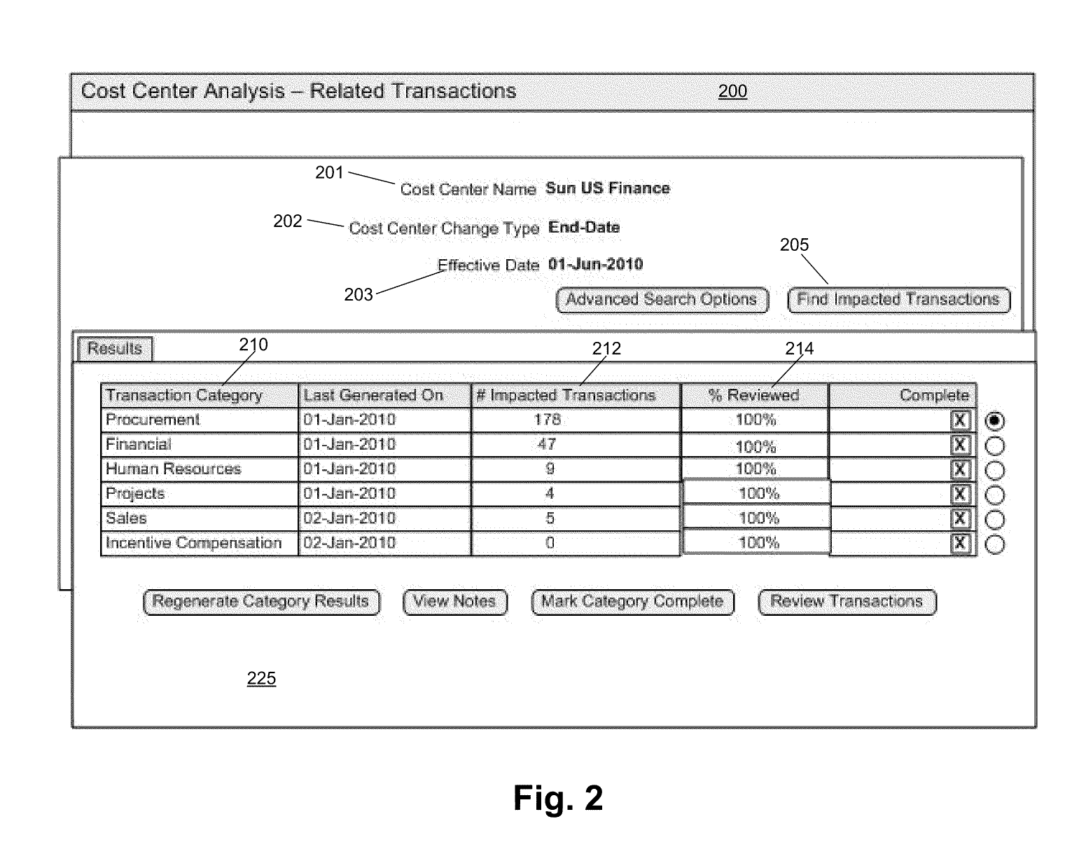

FIG. 2 illustrates a user interface 200 of an impacted transaction report summary in accordance with one embodiment of the invention. At 201, the cost center name is entered. At 202, the cost center change type is entered or selected. At 203, the effective date of the change is entered. A user can then click on a Find Impacted Transactions button 205. In response, a results table 225 displays impacted/affected transaction categories 210, the number of transactions in each category 212, and the percentage of transactions that have been reviewed by the user 214.

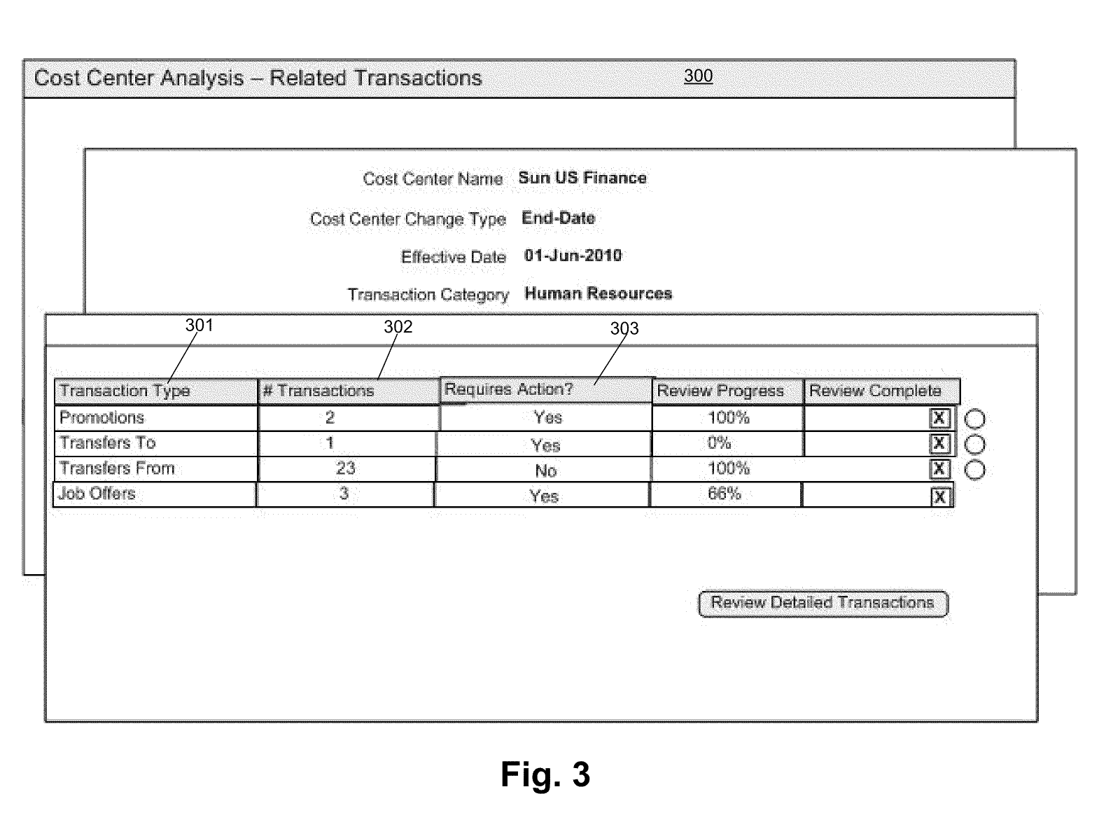

FIG. 3 illustrates a user interface 300 when a specific transaction category from user interface 200 is selected for review in accordance with one embodiment of the invention. In the example of FIG. 3, the human resources category was selected, and transaction types are shown in column 301. For each type, user interface 300 lists the number of transactions 302, and whether the transaction require action (i.e., needs to be reassigned to a new cost center due to changes). For instance, in the example of FIG. 3 where the cost center is being end-dated on Jun. 1, 2010 but there are pending employee transfers into that cost center after this date, those transactions are required to be changed in some way. In contrast, the transfers out of this organization are all before the effective date of the change and thus do not require manual intervention. In some cases, however, if the intention of a reorganization is a reduction-in-force, even transfers out of an organization may need to be altered in some way and thus typically a human with an understanding of the reorganization goals and intentions reviews such transactions.

From user interface 300, a user can drill into the individual transactions for any one transaction type, and optionally directly to the source application and show the related transactions within the native workbench for that business process. Users can then update their review progress.

Embodiments of the invention can be used for department changes in addition to cost center changes. For example, reports can be created for departments that mirror the reports for cost centers, but will return information about transactions which reference the department in question. This report will show not only those setups and transactions which reference the department, but also any other classifications of the organization. For example, if a department is being end-dated, users must deal with the people assigned to those departments, but if that department is also classified as a project owning organization or as a sales team, then that must be part of the report as well so that appropriate actions may be taken in those areas to end-date the organization as a whole if that is the intent.

The report generated by embodiments of the invention can be used by the departments which are notified of a reorganization request to assist in the manual evaluation of all the potentially impacted transactions. The development teams which register each transaction type will also register whether the transactions must be dealt with in order to avoid inconsistency or whether the transactions can remain unchanged without any issues. For example, open expense reports to a cost center which has been end-dated might be OK as long as they post to a date before the end-date of the cost center. A decision should be made by someone in finance about whether the open expenses are appropriate to post to the old cost center or whether they should really be moved to somewhere else since that cost center is being closed.

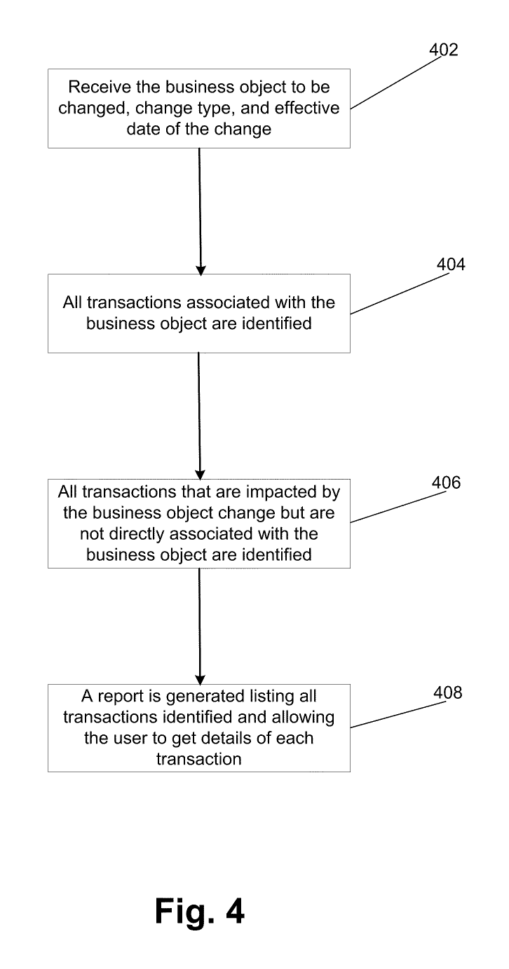

FIG. 4 is a flow diagram of the functionality of impacted transactions module 16 when determining and displaying transactions impacted by a business object change in accordance with one embodiment. In one embodiment, the functionality of the flow diagram of FIG. 4 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 402, the business object to be changed, change type, and effective date of the change in received. In one embodiment, the business object is a cost center, the change type is end-date, and the date of the change is the date when the cost center will cease to exist.

At 404, all transactions directly associated with the business object are identified. In one embodiment, these transactions will have the business object listed as an attribute of the transaction.

At 406, all transactions that are impacted by the business object change but are not directly associated with the business object (i.e., do not include an attribute for that business object) are identified. These are the transactions that in the future are likely to be posted to the changed business object. In one embodiment, during the set-up for these transactions, a business object is identified in sub-ledger accounting.

At 408, a report is generated listing all transactions identified and allowing the user to get details of each transaction.

As disclosed, embodiments identify all transactions impacted by a business object change. The transactions are displayed to a user so each transaction can be assigned to the correct business object after the change.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer readable media having instructions stored thereon that, when executed by a processor, causes the processor to, in response to receiving a business object to be changed, a change type, and a effective date of the change:
identify all first transactions directly associated with the business object;
identify all second transactions not directly associated with the business object but that may be posted to the business object in the future; and
display the first transactions and the second transactions in a user interface.

2. The computer readable media of claim 1, wherein the business object is a cost center.

3. The computer readable media of claim 1, wherein the first transactions comprise an attribute that identifies the business object.

4. The computer readable media of claim 1, wherein the display comprises displaying a plurality of transaction categories and the number of first transactions and second transactions in each transaction category.

5. The computer readable media of claim 4, wherein the display further comprises displaying for each category a plurality of transaction types, and the number of first transactions and second transactions in each transaction type, and whether the number requires action.

6. The computer readable media of claim 1, wherein the first transactions are impacted when the business object is changed.

7. The computer readable media of claim 1, wherein the second transactions may be impacted when the business object is changed.

8. The computer readable media of claim 1, further comprising displaying details of a transaction upon selection of the transaction.

9. A computer implemented method comprising:
receiving a business object to be changed, a change type, and a effective date of the change;
identifying all first transactions directly associated with the business object;
identifying all second transactions not directly associated with the business object but that may be posted to the business object in the future; and
displaying the first transactions and the second transactions in a user interface.

10. The computer implemented method of claim 9, wherein the business object is a cost center.

11. The computer implemented method of claim 9, wherein the first transactions comprise an attribute that identifies the business object.

12. The computer implemented method of claim 9, wherein the display comprises displaying a plurality of transaction categories and the number of first transactions and second transactions in each transaction category.

13. A computer system comprising:
a processor;
a memory coupled to the processor storing instructions that are executed by the processor;
wherein the processor receives organization change information including a business object to be changed, a change type, and a effective date of the change;
in response, the processor identifies all first transactions directly associated with the business object and identifies all second transactions not directly associated with the business object but that may be posted to the business object in the future; and
displays the first transactions and the second transactions in a user interface and identifies the transactions that require user action in response to the organization change.

14. The computer system of claim 13, wherein the business object is a cost center.

15. The computer system of claim 13, wherein the first transactions comprise an attribute that identifies the business object.

16. The computer system of claim 13, wherein the display comprises displaying a plurality of transaction categories and the number of first transactions and second transactions in each transaction category.
